(19) United States
(12) Patent Application Publication
(10) Pub. No.: US 2007/0244730 A1
(43) Pub. Date: Oct. 18, 2007

(54) System and method for a flight by private aircraft

(76) Inventors: Greg Johnson, Goffstown, NH (US); Trey Urbahn, New Canaan, CT (US)

Correspondence Address: KEVIN FARRELL;PIERCE ATWOOD, ONE NEW HAMPSHIRE AVENUE, PORTSMOUTH, NH, 03801, US

(21) Appl. No.: 11/403,183

(22) Filed: Apr. 12, 2006

(51) Int. Cl. G06Q 10/00

(52) U.S. Cl. 705/5

(57) ABSTRACT

The present invention includes a system and method for pricing a flight by private aircraft. The method includes the steps of receiving input data regarding a customer, determining a probability of demand for the aircraft at a predetermined location, calculating a cost of repositioning the aircraft, and pricing the flight by private aircraft in response to the cost of repositioning the aircraft. The method is usable by any number of potential customers in order to maximize the efficiency of the aircraft use while minimizing the costs of chartering the aircraft for the customers. The system of the present invention includes a central computer having a pricing center that is accessible to a plurality of customers. The pricing center is adapted for pricing a flight by private aircraft in response to a probability of demand for the aircraft at a predetermined location and a cost of repositioning an aircraft, wherein the probability of demand for the aircraft at a predetermined location and the cost of repositioning the aircraft are determined in response to input data received from a customer. The system also includes means for accessing the central computer by a customer in order to enter input data to the central computer and receive a price for a flight by private aircraft in response thereto. The system also includes means for reserving an aircraft in response to a customer order.

### BACKGROUND OF THE INVENTION

1. Field of the Invention

The present invention relates generally to the field of electronic commerce, and more specifically to a system and method for pricing a private aircraft charter through a computer network.

2. History of the Related Art

Charter aircraft flights are typically reserved in advance for a round trip from an origin O to a destination D. If a customer is staying at the destination more than a few days, then the aircraft will typically return from the destination D to its base B, either at or near the origin O. When the customer is ready to return to O, the aircraft is redispatched empty to fly to D in order to fly him back. In this example, the aircraft makes two round trips with an unproductive empty leg in each direction.

FIGS. 1A and 1B are schematic representations of the state of the art practice in charter flight reservations. Using the state of the art methodology, a customer flying from origin O to destination D, with a stay of greater than two days, will incur a cost of approximately $26,400 for the use of a Cessna Citation flying 500 miles per hour at $2,200 per hour. While the outbound leg from O to D and the return leg from D to O are occupied, the remaining four legs are unoccupied and are therefore an inefficient and costly use of the aircraft's time. Table 1 shows the cost allocation as represented by FIGS. 1A and 1B.

TABLE 1

| Leg | Description | Miles | Hours | Cost ($) |
|---|---|---|---|---|
| 1 | B to O | 250 | 1.0 | 2,200 |
| 2 | O to D | 1000 | 2.5 | 5,500 |
| 3 | D to B | 1000 | 2.5 | 5,500 |
| 4 | B to D | 1000 | 2.5 | 5,500 |
| 5 | D to O | 1000 | 2.5 | 5,500 |
| 6 | O to B | 250 | 1.0 | 2,200 |
| | Totals | 4500 | 12.0 | 26,400 |

Thus a single customer incurs a cost of $26,400 for the use of a charter aircraft, wherein the total occupied time of the aircraft is only 42% of the gross flight time. As a result, the customer is paying a significant premium for the repeated relocation of the aircraft and resulting empty legs. While this method of pricing has worked in the past, increases in fuel costs for example will continue to increase the costs associated with charter aviation. Accordingly, there is a need in the art for a new and useful method and system for pricing private aircraft flights, and in particular an improved method and system for allocating costs for charter flight travelers.

### SUMMARY OF THE INVENTION

Accordingly, the present invention includes a system and method for pricing a private aircraft flight. The preferred method includes the steps of receiving input data regarding a customer, calculating a cost of repositioning an aircraft, and pricing the private aircraft flight in response to the cost of repositioning the aircraft. The preferred method is usable by any number of potential customers in order to maximize the efficiency of the aircraft use while minimizing the costs of chartering the aircraft for the customers.

The preferred system of the present invention includes a central computer having a pricing center that is accessible to a plurality of customers. The pricing center is adapted for pricing a flight in response to a cost of repositioning an aircraft, wherein the cost of repositioning the aircraft is determined in response to input data received from a customer. The system also includes means, such as for example a computer network, for accessing the central computer by a customer in order to enter input data to the central computer and receive a price for a private aircraft flight in response thereto. The preferred system also includes means, such as a scheduling or reservation program, for reserving an aircraft in response to a customer order.

Further features and advantages of the present invention are described more fully below with reference to its preferred embodiments and the following figures.

### BRIEF DESCRIPTION OF THE FIGURES

FIG. 1A is a schematic representation of a charter flight plan for a departure according to the prior art.

FIG. 1B is a schematic representation of a charter flight plan for an arrival according to the prior art.

FIG. 2A is a schematic representation of a charter flight plan according to a preferred embodiment of the present invention.

FIG. 2B is a schematic representation of a charter flight plan according to a preferred embodiment of the present invention.

FIG. 3 is a state diagram showing certain aspects of the preferred embodiment of the present invention.

FIG. 4 is a flow chart depicting a method for pricing a private aircraft flight according to the preferred embodiment of the present invention.

FIG. 5 is a flow chart depicting a method for pricing a private aircraft flight according to the preferred embodiment of the present invention.

FIG. 6 is a flow chart depicting a method for pricing a private aircraft flight according to the preferred embodiment of the present invention.

FIG. 7 is a flow chart depicting a method for pricing a private aircraft flight according to the preferred embodiment of the present invention.

FIG. 8 is a flow chart depicting a method for pricing a private aircraft flight according to the preferred embodiment of the present invention.

FIG. 9 is a representation of preferred means for allowing a customer to price a private aircraft flight.

FIG. 10 is a representation of a database showing available positioning flights according to the preferred embodiment of the present invention.

FIG. 11 is a representation of a database showing available aircraft according to the preferred embodiment of the present invention.

FIG. 12 is a schematic block diagram of a system for pricing a private aircraft flight according to the preferred embodiment of the present invention.

### DETAILED DESCRIPTION OF THE PREFERRED EMBODIMENTS

The following description of various preferred embodiments of the invention is not intended to limit the invention to these preferred embodiments, but rather to enable any person skilled in the art of electronic commerce to make and use this invention.

The preferred method of the present invention includes the steps of receiving input data regarding a customer, calculating a cost of repositioning an aircraft, applying a risk assessment algorithm to determine a probability of a demand for the aircraft at a predetermined location and pricing the flight by private aircraft in response to the cost of repositioning the aircraft and the demand for the aircraft at a predetermined location. The preferred method is usable by any number of potential customers in order to maximize the efficiency of the aircraft use while minimizing the costs of chartering the aircraft for the customers.

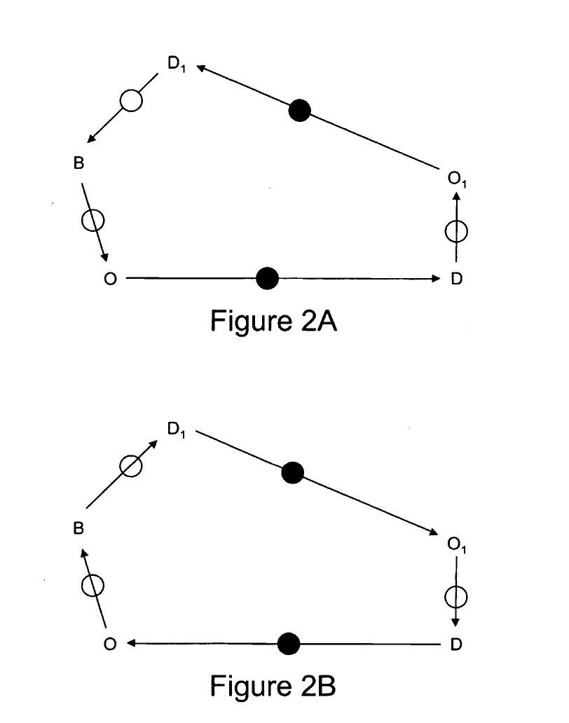

FIG. 2A is a schematic diagram showing aspects of the preferred method, including a first user leaving origin O and arriving at destination D, and a second user leaving origin O1 and arriving at a destination D1, both on an aircraft based at base B. In this departure route of flights, the aircraft starts at base B and is repositioned on an empty leg to origin O, where it picks up a first customer and transports him or her to destination D. From destination D, the aircraft is repositioned on a second empty leg to origin O1, where it picks up a second customer and transports him or her to destination D1. The aircraft then flies a third empty leg in repositioning itself back at the base, B.

FIG. 2B is a schematic diagram showing a return route of flights, using the same reference points and customers referenced above. The aircraft flies a first empty leg from the base B to destination D1, where it picks up the second customer and transports him or her to the origin O1. From O1, the aircraft flies a second empty leg to destination D, where it picks up the first customer and transports him or her to the origin O. Form the origin O, the aircraft flies a final empty leg to its base B.

The preferred methodology described with reference to FIGS. 2A and 2B results in much lower ratio of empty leg travel for the aircraft, resulting in a much more efficient use of the aircraft and a commensurate savings to the customers. The efficacy of the present invention is clearly demonstrated in Table 2, which assumes a Cessna Citation aircraft traveling at 500 miles per hour, a total of ten legs, for two customers.

TABLE 2

| Leg | Description | Miles | Hours | Cost ($) |
|---|---|---|---|---|
| 1 | B to O | 250 | 1.0 | 2,200 |
| 2 | O to D | 1000 | 2.5 | 5,500 |
| 3 | D to O1 | 125 | 0.75 | 1,650 |
| 4 | O1 to D1 | 1250 | 3.0 | 6,600 |
| 5 | D1 to B | 250 | 1.0 | 2,200 |
| 6 | B to D1 | 250 | 1.0 | 2,200 |
| 7 | D1 to O1 | 1250 | 3.0 | 6,600 |
| 8 | O1 to D | 125 | 0.75 | 1,650 |
| 9 | D to O | 1000 | 2.5 | 5,500 |
| 10 | O to B | 250 | 1.0 | 2,200 |
| | Totals | 5750 | 16.5 | 36,300 |

In this case, the total cost of carrying 2 or more customers across four occupied legs is $36,300, or $18,150 for each round trip, substantially less than the $26,400 cost in the earlier case. Overall, the aircraft is occupied for 67% of the total mileage as compared to an occupancy rate of 42% in the prior case.

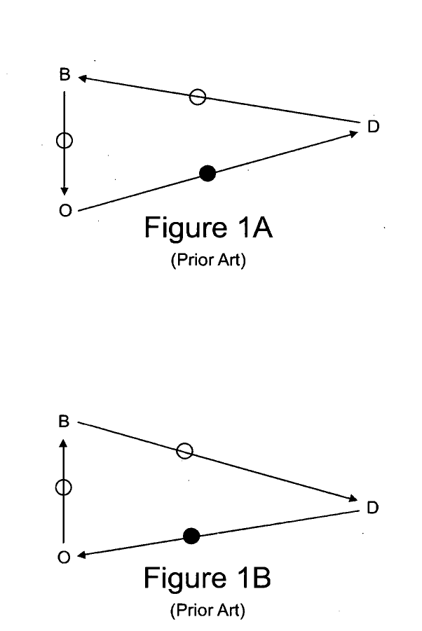

A risk assessment algorithm allocates the total cost of the trips between the two (or more) customers based on the risk. By allocating a disproportionate share of the cost to the first initiating customer, the model allows a lower price to be offered to attract a second customer. In this example, 60% of the cost is allocated to customer A traveling from O to D and the second customer receives a discounted allocation of only 40%. The resulting total expense for the two round trips is divided 60/40 such that the first customer would pay $21,780 for the first roundtrip and the second customer would pay $14,520 for the second roundtrip. Referring back to FIGS. 1A, 1B and Table 1, one skilled in the art will clearly note the increased efficiency and reduced cost to the customer of purchasing a private aircraft flight according to the preferred method of the present invention.

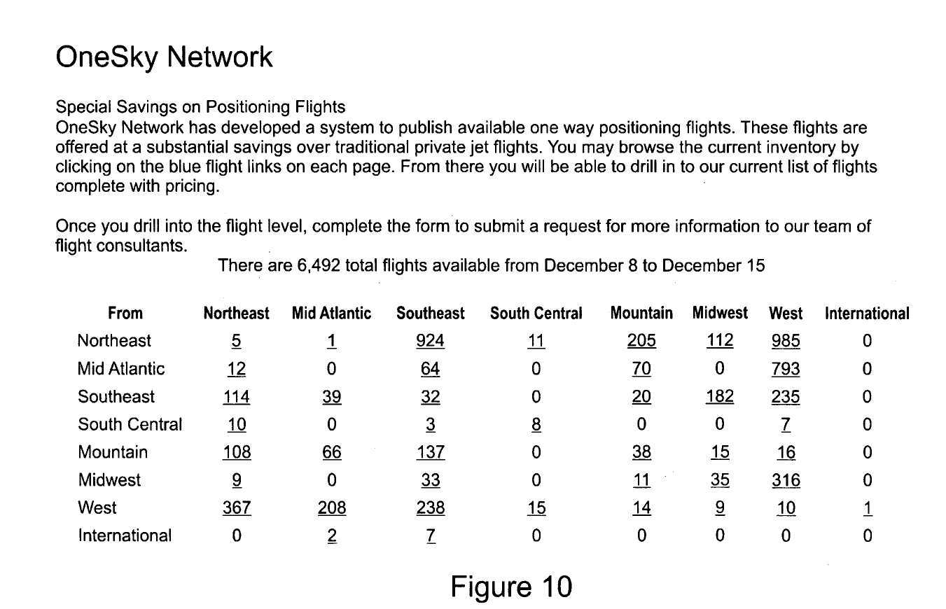

As compared to the prior art methodology described above, both the first customer and the second customer receive a significant discount on the price of a charter flight as priced according to the present invention. For example, FIG. 10 is a matrix of available repositioning flights that a customer might encounter in employing the method of the present invention. As shown, for any particular week, there are a number of aircraft that are, based on existing demand, traveling from one region to another throughout the United States. For example, there are nine hundred and eighty five positioning flights shown between the Northeast to the West for the week selected by the customer. Unlike the state of the art, the method of the present invention renders these flights available to customers traveling between any two of the noted regions.

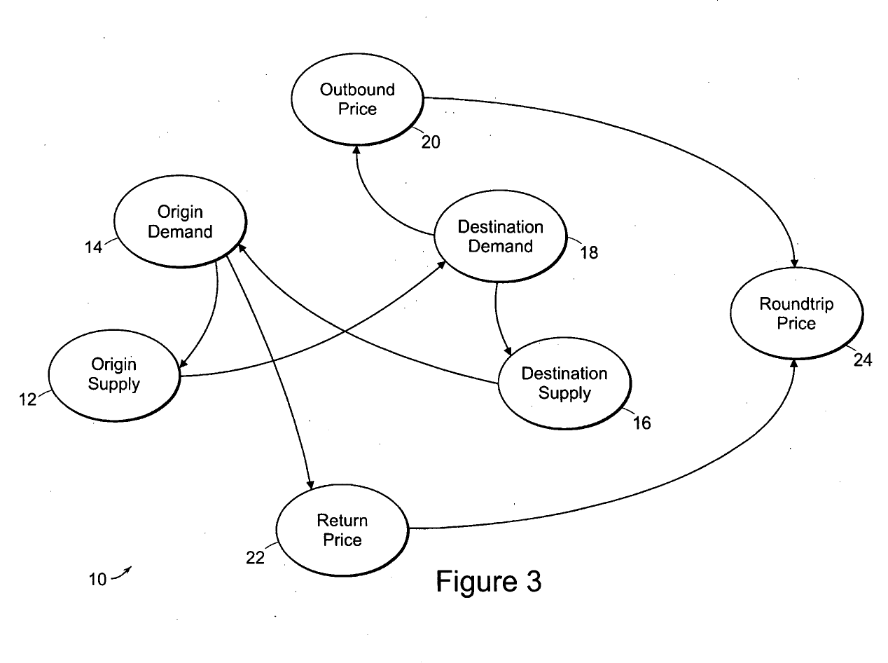

Proper implementation of the pricing system and methodology of the preferred embodiment requires the simultaneous input and manipulation of data from a plurality of sources. As an example, the state diagram 10 of FIG. 3 schematically illustrates this principle. For a customer traveling from origin O to destination D, the system and method of the preferred embodiment require inputs relating to origin supply 12 and origin demand 14. These variables are representative of the customer demand from the origin as well as the aircraft availability at the origin, with certain repositioning costs discussed in greater detail below. The preferred system and method account for destination supply 16 and destination demand 18, which accounts for the demand from any other customers at or near the destination as well as the availability of the aircraft at or near the destination, with certain repositioning costs to be factored in as described below. An outbound price 20 is partially determined in response to the destination supply 16 and the destination demand 18, i.e. more efficient use of the aircraft reduces the price for all customers as shown above. In particular, the price for the first customer is based in part upon the probability of a second customer located at or near the destination as determined by the risk assessment algorithm. Similarly, a return price 22 is partially determined in response to the origin supply 12 and the origin demand 14, again determined in part by the efficient use of the aircraft in carrying more than one charter customer as shown above. The outbound price 20 and the return price 22 are economically indicative of a roundtrip price 24, although the roundtrip price 24 is preferably calculated according to an allocation of the cost of operating and repositioning one or more aircraft for two or more customers.

The roundtrip price 24 for each customer is based in part upon the probability of a counterpart customer located at or near the respective origin or destination during each leg of the round trip. The risk assessment algorithm computes, based upon factors described in detail below, a probability of demand for the aircraft at a predetermined location. The predetermined location varies according to the leg of the flight and the respective origins and destinations of the customers. For a first customer, the predetermined location is his or her destination, including a variable region about his or her destination. The risk assessment algorithm then calculates a probability of demand for the aircraft at or near the first customer's destination. As the probability of demand increases, the probability of an occupied leg from the first customer's destination also increases. Accordingly, as the aircraft is being more efficiently used, substantial savings can be passed on to the first customer in the price of his or her round trip. However, if the probability of demand decreases, the probability of an occupied leg from the first customer's destination also decreases. As such, the cost of the roundtrip flight will be relatively higher to the first customer.

The preferred method of the present invention includes the steps of receiving input data regarding a customer, applying a risk assessment algorithm to determine a probability of a demand for the aircraft at a predetermined location, calculating a cost of repositioning an aircraft, and pricing the flight by private aircraft in response to the probability of a demand for the aircraft at the predetermined location and cost of repositioning the aircraft.

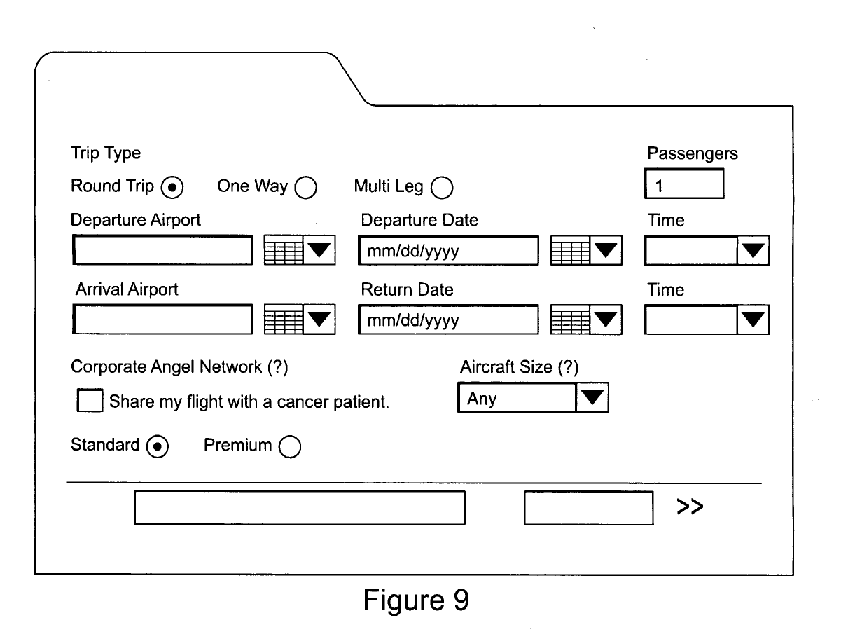

The method of the present invention is preferably performed by a software program operating on a computer that is remotely located from one or more customers. More preferably, a customer may access the method of the present invention through a networked computer having an interface, such as a web browser, that enables him or her to provide the input data directly into the software performing the method. FIG. 9, for example, is illustrative of a user interface that a customer might encounter in providing his or her input data. The input fields shown in FIG. 9 include a departure airport, an arrival airport, a departure date, a return date, a round trip selector, a one-way selector, and a multi-leg selector. Additional inputs that are preferably incorporated by the method of the present invention include a time of day for both the departure and return flights, a number of passengers selector, and an aircraft size selector. Alternative inputs shown in FIG. 9 include a selection for a standard or premium aircraft as well as the option for sharing the flight with a cancer patient.

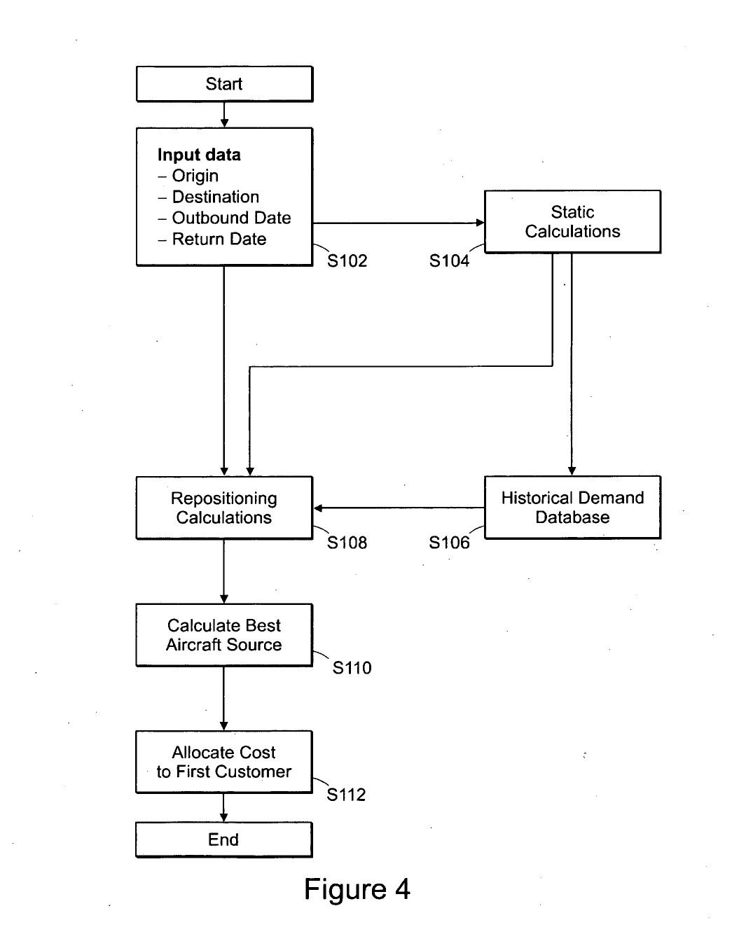

As shown in the flow chart of FIG. 4, step S102 includes inputting data regarding a customer's itinerary. The input data includes at least flight origin O, a destination D, an outbound date and a return date. The input data is forwarded to a static calculator S104, which functions to calculate a base price for the aircraft in response to the customer's input data, as described more fully below. The input data is also fed forward into a repositioning calculator S108, which functions to calculate the cost of repositioning an aircraft in response to the customer's input data.

The static calculator S104 feeds its base price information into a historical demand database S106, which functions to determine a demand for aircraft at the customer's origin and destination based in part on the dates selected. The static calculator S104 also feeds forward into the repositioning calculator S108, in concert with the historical demand that is determined by the historical demand database S106. Thus, the repositioning calculator S108 is the recipient of data streams that include the customer's input data, the base cost of chartering an aircraft in response to the input data, and historical data regarding the demand for aircraft at the origin and destination on the dates selected by the customer.

The repositioning calculator S108 functions to determine a cost of repositioning an aircraft from its base B to the origin O or destination D, or both, depending upon the length of stay and logistics involving other potential customers. In some embodiments, however, the base of the aircraft B and the origin O will be the same or substantially the same location. In such instances, the costs of repositioning the flight on the first leg are zero. In most other cases, the repositioning calculator S108 functions to determine a price for repositioning an aircraft from its base B to the origin O, as selected by the customer, and also from the origin O back to the base B at the end of the round trip. The repositioning calculator S108 further functions to calculate repositioning costs for an aircraft from the destination D1 or origin O1 of another prospective customer that is likely, based upon the historical demand data, to be sharing the same aircraft as described above with reference to. FIGS. 2A and 2B. In some embodiments, however, the destination D and the origin O1 will be the same or substantially the same location, as will the origin O and the destination D1. In such instances, the repositioning costs will be nominal or zero. Further details of a preferred method for calculating the repositioning costs are described more fully below.

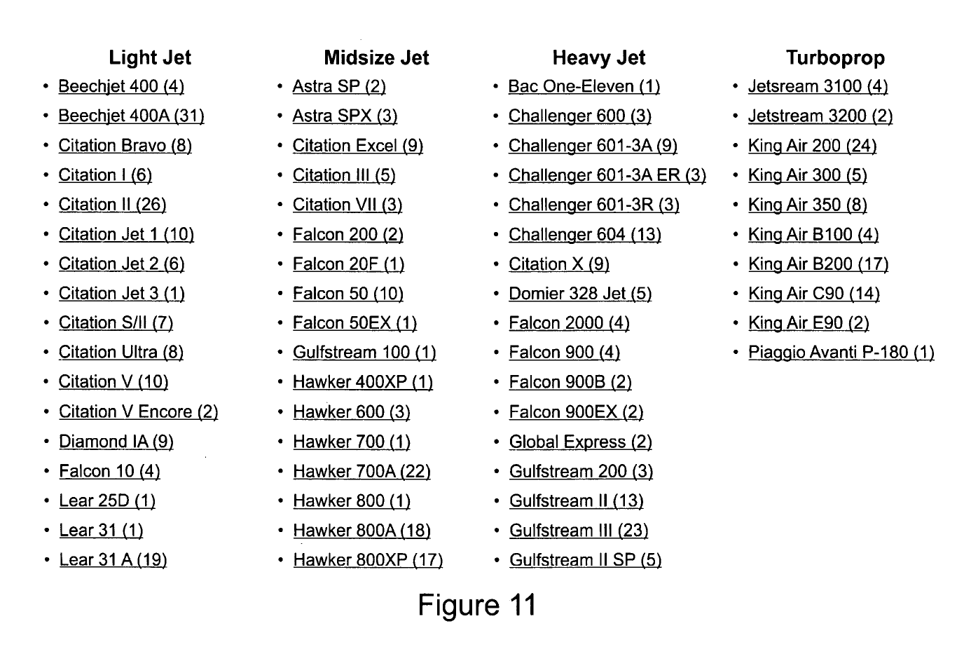

In response to the repositioning costs as determined in step S108, the preferred method then calculates a best aircraft source in step S110. In step S110, the method determines the aircraft that is most efficiently positioned for one or more roundtrips for one or more customers, after factoring the costs of repositioning that aircraft from the base B to the origin O and from a second destination D1 to the base B. Step S110 may alternatively include another step for permitting a customer to select a particular class of aircraft, which in turn then narrows the field of potential aircraft that fit the best source parameters. See for example FIG. 11, which is illustrative of a list or catalogue of aircraft that may be available for use. In step S112, following the selection of the best aircraft; the method recites allocating the cost to a first customer. In the preferred embodiment, the cost is allocated the first customer based upon the cost of repositioning the aircraft and the demand for the aircraft at a predetermined location, i.e. at or near the customer's destination.

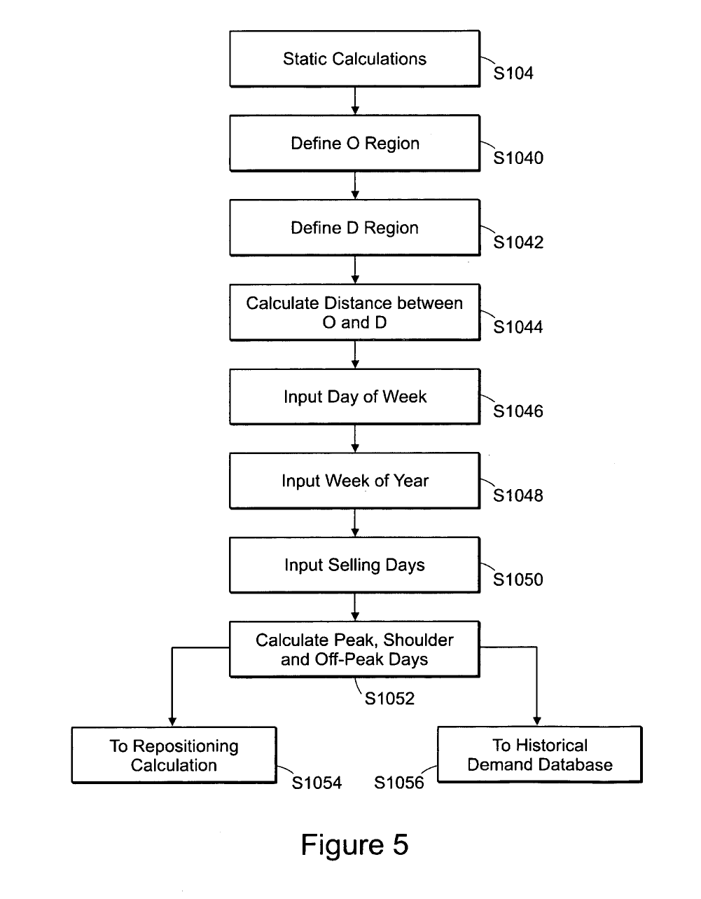

Further details of the static calculator S104 are shown in the flow chart of FIG. 5. The static calculator S104 functions to derive a base price for the customer's flight from origin O to destination D. In step S1040, the method recites defining an origin region, which is defined as a predetermined space around the customer's origin. For example, the origin region for a customer selecting Boston, Mass. as the origin may include the greater Boston area plus a fifty to one hundred mile radius, thus including a greater number of airfields and sources for charter aircraft. In step S1042, the method recites defining the destination region. For a customer destination of Los Angeles, Calif., the destination region will encompass the greater Los Angeles area plus a fifty to one hundred mile radius, thus including a greater number of airfields and potential second customers that increase the destination demand for the aircraft and therefore the probability of demand for the aircraft at that predetermined location. In step S1044, the static calculator S104 calculates the distance between O and D, from which the base price for the charter flight can be derived as either a function of distance or hours in transit.

The base price as determined in step S1044 is modified depending upon the date of departure and return as selected by the customer. In step S1046, the method inputs the day of the week for the departure and return dates. In step S1048, the method inputs the week of the year for the departure and return dates, and in step S1050, the method inputs the number of remaining selling days for the particular trip sought by the customer. In step S1052, the method calculates the peak, shoulder and off-peak days for the departure and return dates selected by the customer. As aircraft supply and demand are largely dependent upon the dates, step S1052 functions to modify the base price of the charter flight based upon the known correlation between the dates selected by the customer and the aircraft supply and demand.

For example, a common charter aircraft flight plan is from the greater New York City area to Florida. It is known that there is a large demand for flights from New York to Florida leaving on a Thursday or Friday, and returning from Florida on a Sunday or a Monday. This weekly demand spike varies throughout the year, as more New Yorkers head to Florida during the winter months than during the summer months. Therefore, if a customer selects this round trip flight with a Friday to Monday turnaround in February, then the base price of the aircraft will increase as the demand for the aircraft is statistically higher for this trip than for an alternative trip covering a substantially equal distance, i.e. New York to Chicago in the same time frame. The resulting modifications to the base price, as determined by step S1052, are fed into the repositioning calculator S108 in step S1054 and the historical demand database S106 in step S1056.

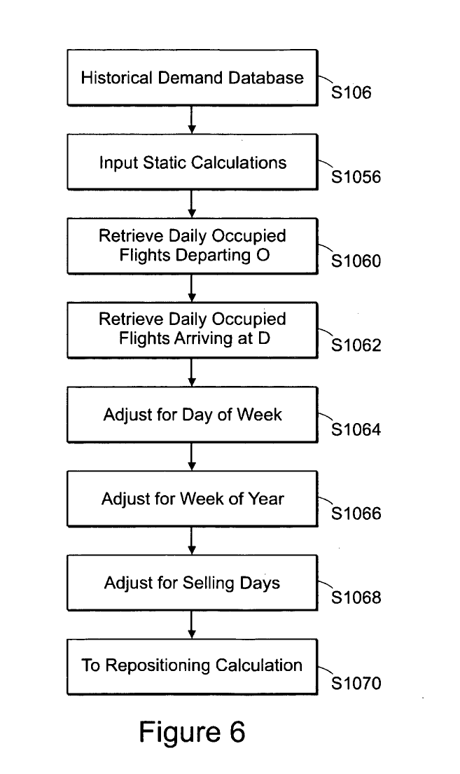

The historical demand database S106 functions to make further adjustments to the base price of the trip based in part on statistical data regarding flight occupancy from the selected origin and destination. As shown in FIG. 6, the historical demand database S106 receives the static calculations in step S1056 as noted above. In step S1060, the method recites retrieving daily occupied flights departing the origin O. In step S1062, the method recites retrieving daily occupied flights departing the destination D. Each of these data points is indicative of a historical demand for an aircraft at the respective location. In step S1064, the historical data for both the origin and the destination is adjusted for the day of the week. Step S1066 makes a similar adjustment for the week of the year, and step S1068 makes a similar adjustment for the remaining number of selling days left before the selected trip. Thus, if the customer intends to travel the Wednesday before a major holiday, such as Thanksgiving in the United States, then the historical demand database S106 will show a high demand for aircraft on that day of the week for that week of the year, and depending upon the remaining selling days, the base price of the trip may be affected accordingly. The adjustments made by the historical demand database S106 are fed into the repositioning calculator S108 in step S1070.

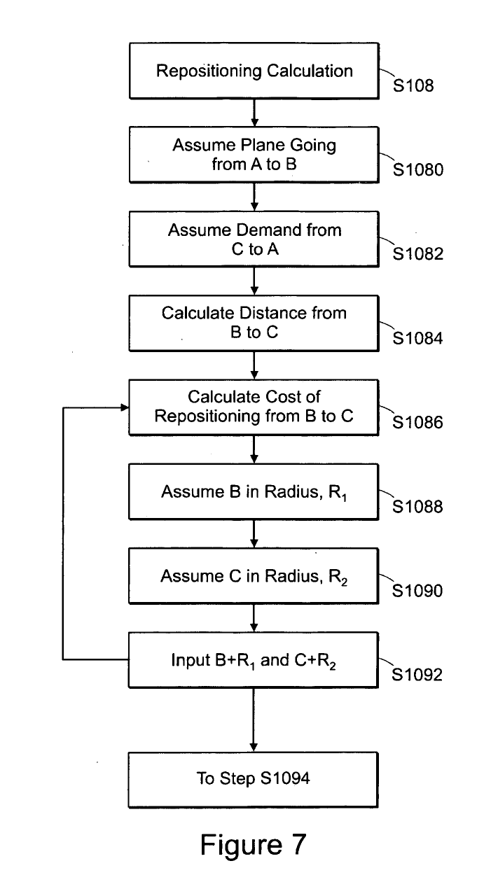

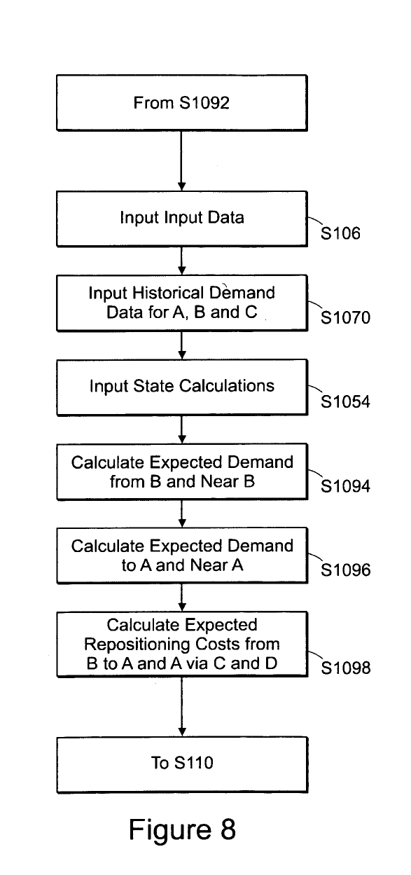

As shown in FIGS. 7 and 8, the repositioning calculator S108 functions to calculate a repositioning cost based upon certain assumptions regarding the supply and demand for aircraft at the origin O and the destination D for one more customers. In step S1080, the method assumes that an aircraft is traveling from a first location A to a second location B. For example, the first location A may be identical or substantially identical to an origin or a destination for a first customer, while the second location B may be identical or substantially identical to a destination or an origin for the first customer.

In step S1082, the method assumes that there is a demand from a third location C to the first location A. For example, the first location A may be identical or substantially identical to an origin or a destination of the first customer. The third location C may be identical to or substantially identical to the destination or the origin of the second customer. In step S1084, the method calculates the distance from the second location B to the third location C. In step S108, the method calculates the cost of repositioning the aircraft from the second location B to the third location C. The cost of repositioning is a function of flight time, which in turn depends upon the distance between the second location B and the third location C, and any other associated costs or fees accrued in the chartering of a flight. A fourth location D, described in more detail below, may be identical to or substantially identical to the destination or the origin of the second customer.

Adjustments to the cost of repositioning the aircraft are made in steps S1088, S1090 and S1092 as shown in FIG. 6. In step S1088, the method assumes that the second location B includes a predetermined radius, R1. In step S1090, the method assumes that the third location C includes a predetermined radius, R2. In step S1092, the new locations, including the radial adjustments thereto, are fed back into step S1084 for recalculation of the repositioning cost from the second location B plus R1 to the third location C plus R2. For example, both R1 and R2 may be set to an initial value of one hundred miles, in which case the repositioning costs should be expected to decline as the distance between the second location B and the third location C is decreased by two hundred miles.

In adding the radial values R1 and R2, however, the method thereby incorporates a greater region for each of the locations, which increasing the demand for aircraft at that particular location plus its radius R1 or R2. The feedback cycle between steps S1084 and S1092 may be continued for a predetermined number of radial adjustments, i.e. one hundred miles, two hundred miles, and three hundred miles. Alternatively, the feedback cycle between steps S1084 and S1092 may be continued until the repositioning costs between the second location B and the third location C are optimized relative to the flight demand from those respective locations, as adjusted by R1 and R2.

Following the initial calculation of the repositioning costs as determined above, the method progresses to step S1094, as shown in FIG. 8. From step S1092, the method recites inputting the input data from step S106. In step S1070, the historical demand data, as determined by the historical demand database S106, is input into the method for the first location A, the second location B and the third location C. The static calculations, as determined by the static calculator S104, are input into the repositioning calculator S108 at step S1054.

It should be understood that the repositioning costs may be negligible or even zero depending upon the location of the aircraft, the respective itineraries of the travelers, and the demand for the aircraft at the respective origins and destinations. In highly trafficked areas, it may be the case that the first customer's destination is the second customer's origin and the first customer's origin is the second customer's destination. In such instances, the only empty leg flight will be to and from the aircraft base B. However, in larger metropolitan areas, it may be the case that the aircraft base is the same as the origin and destination for the first and second customer, in which case there will be no empty leg travel for the aircraft.

Following the foregoing inputs, the method recites calculating the expected demand from the second location B and from near the second location B in step S1094. Preferably, the calculation of the expected demand from near the second location B includes calculating an expected demand from B plus an area around B determined by a radius, which may be identical to the radius R1 discussed above. In step S1096, the method recites calculating the expected demand from the first location A and from near the first location A. Preferably, the calculation of the expected demand from near the first location A includes calculating an expected demand from A plus an area around A determined by a radius, which may be identical to the radius R1 discussed above. Thus, steps S1094 and S1096 determine the expected demand for aircraft at or near the first position A and at or near the second position B, wherein the first location A may be identical or substantially identical to an origin or a destination for a first customer, while the second location B may be identical or substantially identical to a destination or an origin for the first customer.

As described thus far, the first customer is traveling between the first location A and the second location B, and the second customer is traveling between the third location C and the fourth location D. Accordingly, in step S1098, the method recites the step of calculating the expected repositioning costs from the second location B to the first location A via the third location C and the fourth location D. In doing so, the method assumes that the transport of the aircraft from the second location B to the third location C is an empty repositioning leg. The second customer occupies the aircraft from the third location C to the fourth location D, from whence the aircraft is repositioned to the first location A on another empty leg. As such, the first customer, in repositioning the aircraft from the second location B to the first location A has a portion of that cost discounted due to the probability that there will be a second customer who is occupying the aircraft between the third location C and the fourth location D.

Following the calculation of the repositioning costs, the method proceeds to step S110, in which the method calculates a best aircraft source. In step S110, the method determines the aircraft that is most efficiently positioned for one or more roundtrips for one or more customers, after factoring the costs of repositioning that aircraft from the second location B to the first location A via the third location C and the fourth location D. Step S110 may alternatively include another step for permitting a customer to select a particular class of aircraft, which in turn then narrows the field of potential aircraft that fit the best source parameters. FIG. 11 is illustrative of a list or catalogue of aircraft that may be available for use.

In step S112, following the selection of the best aircraft; the method recites allocating the cost to a first customer. In preferred embodiments, the cost is allocated to the first customer in response to the repositioning costs associated with the aircraft and the probability of a demand for the aircraft at a predetermined location. Typically, the predetermined location is at or near the first customer's destination. For example, the first customer intends to travel roundtrip from Boston to Fort Lauderdale. The selected aircraft (or nearest aircraft) is located 100 miles from Boston and thus must be initially repositioned to that origin. Based upon the aforementioned calculations, including the static and historical demand calculations, the risk assessment algorithm of the present invention determines that there is a seventy percent probability that a second customer would like to charter the aircraft from Fort Lauderdale to or near Boston. Moreover, the risk assessment algorithm determines that there is an eighty percent chance that a second customer would like to charter the aircraft from a predetermined location within one hundred miles of Fort Lauderdale to or near Boston. Accordingly, the price of the round trip to the first customer is discounted, because of the high probability that a second customer will pay for the use of the aircraft during what would otherwise be an empty leg from or near Fort Lauderdale to or near Boston. Thus the first customer pays a fraction of the total costs of the round trip, wherein the actual amount of the discount is determined in part in response to the probability that there will be a second customer at or near the first customer's destination.

In operation, the method does not require that the first and second customers are familiar with each other's flight plans. Rather, the methodology of the present invention prices each individual customer's flight on a private aircraft based on the repositioning costs of the aircraft and the probability of demand at the predetermined location generated by the risk assessment algorithm. As such, each customer is receiving a price for a flight on a private aircraft that is discounted from the nominal price of the charter flight. As one customer's destination is another customer's origin, the relative discounts will be determined by the relative probability of demand at the respective locations. As previously noted, the demand for aircraft arriving in Florida from New York on or near the weekend is high, and the demand for aircraft traveling in the opposite direction is low. Thus, a customer traveling from Florida to New York on a Thursday will receive a relatively large discount, as there is a high demand for aircraft traveling from New York to Florida on both Thursday and Friday. Similarly, if the customer is traveling from New York to Florida on the following Sunday, the price will be discounted further as there is a high demand in Florida at that time for aircraft returning to or near a base in New York.

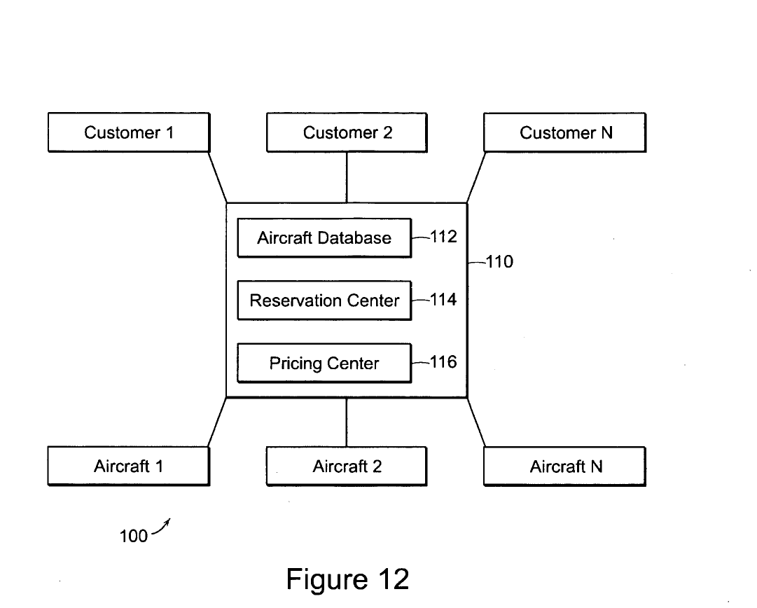

The method of the present invention is most preferably performed by the system 100 of the present invention. As shown in FIG. 12, the system 100 of the present invention preferably includes a central computer 110 having a pricing center 116. The pricing center 116 is preferably adapted for pricing a flight by private aircraft in response to a probability of demand for the aircraft at a predetermined location and a cost of repositioning an aircraft as described above. The probability of demand for the aircraft at a predetermined location and the cost of repositioning the aircraft are determined in response to input data received from a customer. Preferably, the pricing center 116 utilizes a risk assessment algorithm of the type described above in order to determine the probability of a demand for the aircraft at a predetermined location. As noted, the predetermined location is most typically a location at or near the destination of the customer. The pricing center 116 is adapted to price a flight by private aircraft at least in response to the probability of a demand for the aircraft at a predetermined location, typically a location at or near the customer's selected destination. As the probability of demand for the aircraft at or near the customer's selected destination increases, the pricing center 116 is adapted present a lower price to the customer for the reasons discussed above. Conversely, as the probability of demand for the aircraft at or near the customer's selected destination decreases, the pricing center 116 is adapted to present a higher price to the customer.

The central computer 110 also preferably includes an aircraft database 112 and a reservation center 114, which in cooperation with the pricing center 116 enable a customer to purchase a flight according to the method described herein. The central computer 110 is preferably a server that is configured for communication with one or more networked computers and further adapted to run software that operates according to the method described herein. Alternatively, the central computer 110 may be configured as more than one networked computer or server that operate in a parallel or serial manner in performing the method of the present invention.

The system 100 of the present invention further includes means for accessing the central computer 110 by a customer. Preferably, a customer may access the central computer 110, enter input data to the central computer 110, and receive a price for a flight by private aircraft in response thereto according to the method of the present invention. Suitable means for accessing the central computer 110 include a networking capability configured into the central computer 110, which may include one or ports, servers, other computers, or wired or wireless connections through which a user may access the data and software disposed on the central computer 110, and in particular the reservation center 114 as described below.

The system 100 of the present invention also preferably includes means for reserving an aircraft in response to a customer order. Suitable means for reserving an aircraft in response to a customer order include the reservation center 114 and the aircraft database 112, through which the central computer 110 may, at the user's selection, pick the appropriate aircraft and communicate a reservation to the operator of that aircraft. Preferably, the owners and operators of the aircraft, such as aircraft 1, aircraft 2 and aircraft N shown in FIG. 12, are in communication with the central computer 110, and in particular with the aircraft database 112, for indicating the position and availability of the respective aircraft. More preferably, the owners and operators of the aircraft may be permitted selected access to the central computer, such as through a user account, in order to update and monitor the position and availability of their respective aircraft. Other information that may be inputted into the aircraft database 112 includes information regarding the current location, permanent base and anticipated location for each of the aircraft available to the customer through the system 100 and method of the present invention.

The customer preferably accesses the central computer through the reservation center 114, which is in communication with the pricing center 116. The reservation center 114 functions to provide a user interface between the customer and the central computer 110 that enables the customer to make a timely and efficient reservation for a charter aircraft. The reservation center 114 is adapted to provide information to the customer regarding the availability of particular flights and particular aircraft, and further adapted to receive, store and transmit information regarding the customer's input data, described above, to one or more other portions of the central computer 110.

In a preferred embodiment, the reservation center 114 is accessible through a network connection between the central computer 110 and a personal computing device of the customer. Suitable personal computing devices include personal computers, laptop computers, portable digital assistants, mobile wireless telephones that are Internet ready, and any other such device that is connectable to a server such as for example the central computer 110. The customer, in accessing the reservation center, may be presented with data input fields, tables and menu selections as shown in FIGS. 9, 10 and 11. Alternatively, the customer may access the reservation center 114 through more traditional means such as a standard telephone, through which one can make flight reservations as is known in the state of the art.

FIG. 9, as described above, is illustrative of a user interface that a customer might encounter in providing his or her input data to the reservation center 114. The input fields shown in FIG. 9 include a departure airport, an arrival airport, a departure date, a return date, a round trip selector, a one-way selector, and a multi-leg selector. Additional inputs that are preferably incorporated by the system 100 of the present invention include a time of day for both the departure and return flights, a number of passengers selector, and an aircraft size selector. Alternative inputs shown in FIG. 9 include a selection for a type of aircraft as well as the option for sharing the flight with a cancer patient.

As noted above, FIG. 10 is a matrix or table of available repositioning flights that a customer might encounter when interacting with the reservation center 114 of the system 100 of the present invention. As shown, for any particular week, there are a number of aircraft that are, based on existing demand, traveling from one region to another throughout the United States. For example, there are nine hundred and eighty five positioning flights shown between the Northeast to the West for the week selected by the customer. Unlike the state of the art, the system 100 of the present invention renders these flights available to customers traveling between any two of the noted regions through the reservation center 114.

Preferably, the system 100 permits access to the central computer 110 for two or more customers simultaneously or substantially simultaneously in order to maximize the use of the positioning flights and thereby allow each and every customer substantial savings in their charter flight purchases. For example, the system 100 of the present invention preferably permits customer 1, customer 2 and customer N to simultaneously access the central computer 110 and in particular the reservation center 114 as shown in FIG. 12. In doing so, the system 100 permits customer 1 and customer 2 to make a reservation of the type described with reference to FIGS. 2A and 2B, without having to coordinate amongst themselves. By performing the method of the present invention, the central computer 110 readily updates and reconfigures existing and expected demand values as new customers access the system 100 and place reservations. Thus, as customer 1 makes a reservation for a round trip flight from O to D, customer 2 can make a reservation for a round trip flight from O1 to D1. Similarly, three or more customers may reserve a combination of one-way or round trip flights that utilize the methodology of the present invention to generate substantial cost savings. As noted above, the method and system 100 of the present invention preferably connect two or more distinct itineraries via repositioning flights, and thereby each of the customers a substantial amount over the traditional methods and systems employed in the state of the art.

As a person skilled in the art electronic commerce will recognize from the previous detailed description and from the figures and claims, modifications and changes can be made to the preferred embodiments of the invention without departing from the scope of this invention defined in the following claims.

We claim:

1. A method for pricing a flight by private aircraft comprising:
(a) receiving input data relating to a proposed itinerary of a first customer;
(b) calculating a cost of repositioning an aircraft in response to the proposed itinerary;
(c) applying a risk assessment algorithm to determine a probability of a demand for the aircraft at a predetermined location, and
(d) pricing the flight by private aircraft in response to the cost of repositioning the aircraft and the probability of a demand for the aircraft at the predetermined location.

2. The method of claim 1 wherein the input data includes an origin, a destination, an outbound date and a return date.

3. The method of claim 1 further comprising the step of (e) calculating a base price of the flight by private aircraft in response to a plurality of static calculations performed on the input data.

4. The method of claim 3 wherein the plurality of static calculations include defining an origin region, defining a destination region, calculating a distance between the origin and destination, and calculating a peak day, shoulder day and off-peak day value for the flight.

5. The method of claim 1 further comprising the step of (f) computing a historical demand for flights from the origin to the destination.

6. The method of claim 5 further comprising the step of (g) computing a historical demand for flights from the destination to the origin.

7. The method of claim 1 wherein step (d) further includes the step of assuming an aircraft going from a first location A to a second location B.

8. The method of claim 7 wherein step (d) further includes the step of assuming a demand for an aircraft going from a third location C to the first location A.

9. The method of claim 8 wherein step (d) further includes the step of calculating a distance between the second location B and the third location C.

10. The method of claim 9 wherein step (d) further includes the step of calculating a cost of repositioning the aircraft from the second location B to the third location C.

11. The method of claim 10 wherein the second location B is one of an aircraft base or an origin for a second customer.

12. The method of claim 10 wherein the second location B is one of an aircraft base or a destination for a first customer.

13. The method of claim 5 wherein step (f) further comprises the steps of retrieving historical data regarding occupied flights departing an origin and occupied flights arriving at a destination.

14. The method of claim 13 wherein the historical data is adjusted in response to the day of the week.

15. The method of claim 13 wherein the historical data is adjusted in response to the week of the year.

16. The method of claim 13 wherein the historical data is usable by the risk assessment algorithm to determine probability of a demand for the aircraft at the predetermined location.

17. The method of claim 16 wherein the predetermined location is at or near a destination input by the first customer.

18. A system for pricing a flight by private aircraft comprising:
a central computer having a pricing center, the pricing center adapted for pricing a flight by private aircraft in response to a cost of repositioning an aircraft and a probability of a demand for the aircraft at a predetermined location, the cost of repositioning the aircraft and the predetermined location determined in response to input data received from a customer;
means for accessing the central computer by a customer such that a customer may access the central computer, enter input data to the central computer, and receive a price for a flight by private aircraft in response thereto; and
means for reserving an aircraft in response to a customer order.

19. The system of claim 18 further comprising an aircraft database including information regarding the current location, permanent base and anticipated location for the aircraft.

20. The system of claim 18 wherein the means for accessing the central computer by a customer comprises a reservation center in communication with the pricing center.

21. The system of claim 20 wherein the reservation center is accessible through a network connection between the central computer and a personal computing device of the customer.

22. The system of claim 16 wherein the means for accessing the central computer by a customer permits access to the central computer for two or more customers.

23. A method of operating a charter aircraft comprising:
repositioning the aircraft to a first location for a first customer;
transporting the first customer from the first location to a second location;
repositioning the aircraft from the second location to a third location for a second customer; and
transporting the second customer from the third location to a fourth location.

24. The method of claim 23 wherein the aircraft is repositioned to the first location from a base.

25. The method of claim 23 further comprising the step of repositioning the aircraft from the fourth location to a base.

26. The method of claim 23 wherein the first location is an origin of the first customer.

27. The method of claim 23 wherein the second location is a destination of the first customer.

28. The method of claim 23 wherein the third location is an origin of the second customer.

29. The method of claim 23 wherein the fourth location is a destination of the second customer.

30. The method of claim 23 further comprising the step of pricing a charter flight for the first customer in response to the probability of a demand for a flight transporting the second customer from the third location to the fourth location.

31. The method of claim 23 further comprising the step of pricing a charter flight for the second customer in response to the probability of a demand for a flight transporting a third customer from the second location to the first location.

32. The method of claim 31 wherein the first customer and the third customer are identical.
